(19) United States
(12) Patent Application Publication
(10) Pub. No.: US 2018/0019976 A1
(43) Pub. Date: Jan. 18, 2018

(54) System, Apparatus And Method For Massively Scalable Dynamic Multipoint Virtual Private Network Using Group Encryption Keys

(71) Applicant: Intel Corporation, Santa Clara, CA (US)

(72) Inventors: Omer BEN-SHALOM, Rishon Le-Tzion (IL); Alex NAYSHTUT, Gan Yavne (IL); Ned M. Smith, Beaverton, OR (US)

(21) Appl. No.: 15/209,949

(22) Filed: Jul. 14, 2016

(51) Int. Cl. H04L 29/06; H04L 9/30; H04L 9/14; H04L 12/18; H04L 12/46; H04L 12/761

(52) U.S. Cl. CPC H04L 63/0428; H04L 12/4641; H04L 45/16; H04L 9/14; H04L 12/185; H04L 9/30; H04L 2209/24

(57) ABSTRACT

In one embodiment, a hub logic is to provision a plurality of group private keys for a dynamic multipoint virtual private network (DMVPN) group associated with a function of a plurality of devices, provide a group public key for the DMVPN group to the plurality of devices and provision each of the plurality of group private keys to one of the plurality of devices, to enable one or more subsets of the plurality of devices to negotiate a traffic encryption key without interaction with a system having the hub logic. Other embodiments are described and claimed.

### TECHNICAL FIELD

Embodiments relate to enhancing security in a network environment.

### BACKGROUND

Creating dynamic secure network groups in current network environments is technically challenging in that a dedicated infrastructure is typically used to support group membership for multiple computing devices. This dedicated infrastructure performs key management activities for the group members in order to allow them to securely communicate.

A common method of establishing infrastructure dynamic protected tunnels of a virtual private network (VPN) is via a dynamic multipoint VPN (DMVPN). One issue as to complexity with this implementation is a key management protocol that uses a key management server as the dedicated infrastructure to handle distribution of authentication keys, along with message integrity and confidentiality keys, between the members. This central key management approach increases complexity and exposes a central point of failure. Because of dynamic member-member tunnel creation, a system actually includes exponential (O(N²)) distinct connections, which can undesirably increase complexity.

### BRIEF DESCRIPTION OF THE DRAWINGS

FIG. 1 is a block diagram of a network in accordance with an embodiment of the present invention.

FIG. 2 is a flow diagram of a method in accordance with one embodiment of the present invention.

FIG. 3 is a flow diagram of a method in accordance with another embodiment of the present invention.

FIG. 4 is a flow diagram of a method in accordance with a still further embodiment of the present invention.

FIG. 5 is a block diagram of an example system with which embodiments can be used.

FIG. 6 is a block diagram of a system in accordance with another embodiment of the present invention.

FIG. 7 is a block diagram of a system in accordance with another embodiment of the present invention

### DETAILED DESCRIPTION

In various embodiments, key management activities within a network of devices can be realized via a peer-to-peer model using group keys, instead of arbitrated key management based on multiple spoke-hub communications. More specifically, a group authentication key management scheme can be used to establish groups of devices (and in some embodiments, groups formed of functions within such devices) and provide group key material to enable authentication of membership in a group (while preserving privacy of individual devices, in many cases). In specific embodiments described herein, group keys may be based on an Intel® Enhanced Privacy Identifier (EPIDs) system. In this way, a peer-based key generation model allows group members to all use the same group public key to verify message authentication codes between members directly without reference to a central entity, such as a certificate directory/arbitrator. Nevertheless, each group member possesses a unique group private key to ensure group non-repudiation of each member's messages.

Although the scope of the present invention is not limited in this regard, embodiments are applicable to many different types of computing networks. Of particular interest in some cases is an Internet of things (IoT) network in which a variety of different computing devices, some potentially minimally compute intensive devices, such as sensors and actuators and so forth, couple together in a given network or portion thereof. Particularly in embodiments that communicate amongst such IoT devices, group membership, and therefore authentication techniques, may be based at least in part on a device type or class in order for a verifier to understand the expected behavior of the companion device. In particular embodiments, a group of devices may be associated with a particular function that each of the devices can perform. As such, individual IoT devices may be included in multiple groups, where such devices include multiple functions, with each such group associated with a different one of these functions. Understand further that in other situations, devices can flexibly and dynamically join and exit groups, and embodiments contemplate the dynamic addition/subtraction of devices from a given group and corresponding revocation of associated keys or other credentials.

As one particular implementation example, a heating ventilation air conditioning (HVAC) controller cares that a temperature sensor in a particular room or location is sensing temperature, not that it has a particular unique identity. Any temperature sensor may suffice whether it is found on a beacon, clock radio, wearable or other device. Embodiments may associate a group with this temperature sensing function, although many different device types may provide for this functionality. As such, a number of disparate devices within a network or portion thereof can be a member of an EPID group such that the HVAC controller can authenticate its relevance to participate in the HVAC control activity. Because of this capability, each member has a single validation certificate, removing the need to either distribute or query for individual certificates. With this capability, the overall complexity of certificate management overhead can be simplified. This is the case, as the verifier can store/cache a single certificate for all devices that send a signed message. In contrast, certificate management without an embodiment can be more challenging when every device has its own certificate. In that case, each verifier obtains (or caches) a certificate for every device from which it receives communication. If the data message size is small, then supplying a certificate for each message may be impractical.

Not requiring individual certificates for members of a common group enables group members to directly negotiate, e.g., traffic encryption keys, with peers without involvement of a central entity such as a hub server as described herein (beyond the initial group key generation). Negotiated symmetric keys may be temporal. Nevertheless, there may be a natural hub-and-spoke relationship occurring between an information consumer or subscriber, such as a HVAC controller, and a group of information providers or publishers, such as temperature sensors in each room, such that an existing pair-wise key may be refreshed periodically. In some embodiments, symmetric key refresh may be preferred over frequent re-negotiation of temporal keys using an EPID group. In embodiments described herein, O(N²) complexity can be simplified by reducing the size of N into smaller groups. Stated another way, the size of any given group can be smaller than the number of devices in a given network entity, as grouping may be according to function (vs. unique identities). In this way, multiple groups of small N may be present such that the complexity for key management approaches O(N log N²). As such, linear complexity is realized, rather than the exponential complexity of a central key management system. Here, real-time dependency on a central infrastructure is limited to the initial join of a new spoke or, in some embodiments, without any join operations. In all cases this removes all subsequent spoke-hub interactions.

Using embodiments of the present invention, performance can increase, as the time to create a new spoke-spoke tunnel is reduced by eliminating initial traffic to proceed through a hub until the other side retrieves a member-specific certificate. Such performance enhancement may be especially significant in cases where there are a number of members with short lived sessions. Examples of such short lived sessions include real time content communication (e.g., audio and video), cloud-based collaboration for an enterprise use case, and other latency sensitive traffic types that traverse the VPN environment towards a recipient on a spoke that does not yet have a secure association with the sending spoke.

Embodiments may further provide enhancements with regard to scalability, as a single common community key can support any number of hosts that are part of the same VPN domain. Still further, embodiments enhance a network arrangement in that dependency on the state of the hub and communication to/from the hub become relevant only on a new member join (or not at all). Existing members are completely autonomous beyond the initial group key provisioning. As such, using an embodiment, there is no real-time dependency for secure peer-to-peer communication, and as such, a management entity is not in the critical path.

To realize embodiments of the present invention, first a group key provisioning process may be performed, in which each group member is provisioned with a group (e.g., EPID) private key using a key management service. In different embodiments, one of the members may serve as the EPID group leader for this purpose or a public server may be recognized as the group leader. The group leader (GL) may employ an Intel® EPID join protocol, in one embodiment, to provide the DMVPN group private keys to each member. Note that in some embodiments, the group name may be chosen to overlap an Internet protocol version 6 (IPv6) multicast address if the DMVPN interactions are to occur on a IPv6 multicast VPN. The group public key may be certified by assigning the name of the group (e.g., multicast address) to the EPID group name. Stated another way, a group name and a multicast address for the DMVPN may be synonymous. This certificate ensures the group leader is authorized to function in this capacity. Note that a group policy that uses a multicast address to be synonymous the EPID group name simplifies group policy management such that anyone knowing the EPID group also knows how to configure the IP multicast; or if the multicast address is known the device already knows which EPID group credential to obtain from the group leader.

After this group key provisioning process, members of the group (including subsets of the group) may enter into one or more group symmetric key exchanges. For example, publish-subscribe groups or subsets within the group may perform symmetric key exchange protocols to set up secure channels for communication of the publications. As such, group members may obtain group symmetric keys for message integrity and/or confidentiality by performing a key exchange protocol. This symmetric integrity and/or confidentiality key(s) may be wrapped using a key encryption key (KEK), as described below.

This entire message may be multicast over a group multicast channel. In this way, any recipient of this initial message (m0) can authenticate the KEK to the group and subsequently re-transmit the message without loss of authenticity. For example, if the original sender is a sleepy node, a gateway device may re-transmit the message to subscribers while the originator enters into a sleep state. In this way, a low power device can wake to perform, e.g., a sensing function, communicate sensed data, and then return to the sleep state.

In an embodiment, each node that receives the initial message m0 can configure the IP layer multicast VPN using the symmetric keys contained therein. An unlimited number of subsequent messages (m1-mn) can thereafter be transmitted within the group specific DMVPN. In embodiments herein, this DMVPN is highly efficient for intra-group exchanges because symmetric cryptography is used from this point forward. Even sleepy nodes can wakeup into the DMVPN context without incurring the key exchange overhead.

Due to the extreme scalability, a lower level entity device (e.g., server pod or even single server level) can perform the group key management activities, such that embodiments may be used in virtualization environments. Using group keys as described herein, hub-spoke exchanges can be avoided, increasing performance and reducing latency. Still further embodiments reduce complexity involved in DMVPN, increasing scalability, stability and performance, by using group keys to replace per-member keys.

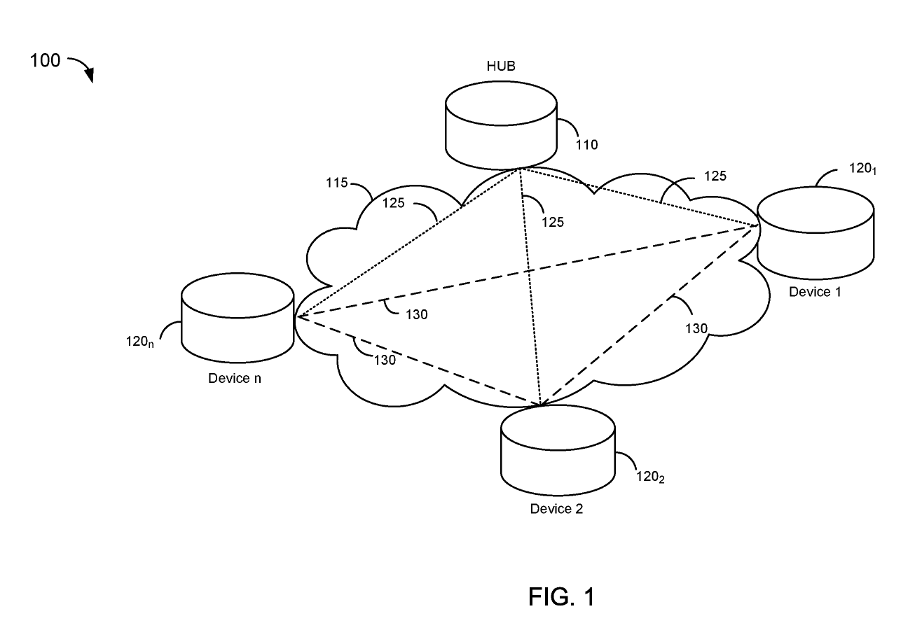

Referring now to FIG. 1, shown is a block diagram of a network in accordance with an embodiment of the present invention. A network 100 is implemented using a DMVPN configuration to enable dynamic multipoint VPNs to be established between a variety of different devices. More specifically as described herein, devices may be collected into subsets or groups, where each device of the group is associated with a common function that each of the devices is capable of performing. Understand that in some embodiments, the different devices may be members of multiple groups, depending upon functionality provided within each of the devices.

With reference to FIG. 1, understand that network 100 may be all or a portion of any type of network of computing devices, ranging from small local networks, such as a local area network (LAN), wireless LAN (WLAN), piconet, or other local wireless network of, e.g., IoT devices. In other cases at least some of the devices within network 100 may be remotely located and connected together, e.g., via the Internet.

Understand that different types of devices are possible within network 100. Specifically, illustrated is a hub system 110. Hub system 110 may be configured to operate as a group leader. In different cases, hub system 110 may be a public server of a cloud service provider, such as a given multi-tenant datacenter. In other cases, hub system 110 may be an elected group leader for a given group, e.g., as configured by a domain or group owner, and can be implemented as a server computer, desktop computer, laptop, tablet, portable device or other computing device configured to perform group leader functions as described herein.

As illustrated, hub system 110 couples to a plurality of computing devices 120₁-120ₙ. More specifically, a one-time connection 125 may occur between hub system 110 and each of devices 120 to perform a key provisioning process as described herein. Thereafter, connectivity between hub system 110 and devices 120 may or may not continue. By providing a one-time coupling of devices for purposes of a group key provisioning arrangement as described herein, improved efficiency is realized in that the latency and other overhead of communicating with hub system 110, e.g., before enabling given interactions with other devices, can be avoided. After the group key provisioning process has occurred such that devices 120 include group keys, interactions between devices 120 within a DMVPN can occur by way of DMVPN tunnels 130, without any further involvement with hub system 110. (Note that in some cases hub system 110 itself may be a group member such that interaction between a given device 120 and hub system 110 by way of a DMVPN tunnel may occur; however, such interaction is without the involvement of group key provisioning logic of hub system 110.)

As such, with the arrangement shown in FIG. 1, group symmetric key exchanges by devices 120 of a group can occur without interacting further with hub system 110. And responsive to such symmetric key provisioning, devices 120 may communicate, e.g., according to a publish-subscribe technique without any further interaction with hub system 110. Understand while shown with a limited number of devices in FIG. 1, a DMVPN as described herein can accommodate a massively large number of devices. Furthermore, multiple independent DMVPNs can be realized in which different numbers of devices couple together in a given DMVPN, e.g., according to a group in which all group devices have a common function that is used to identify or associate the group.

Note that in some embodiments, the devices shown in FIG. 1 may include a trusted execution environment (TEE), in which the security operations described herein may be performed. To this end, in at least some embodiments, a given processor or system on chip (SoC) (or portion thereof) included in the different computing devices may include separate secure circuitry (or may be configured) to operate in a secure mode. Such secure mode provides the TEE that is isolated from non-secure hardware/software/firmware. In example embodiments, a TEE of the device may leverage Intel® Software Guard Extensions (SGX), Intel® MemCore, Intel® Converged Security Engine (CSE), Intel® virtualization technology (VT-X), Intel® IOT-OS with Smack, ARM TrustZone, or any other secure environment. In some cases, the TEE may be implemented in a secure co-processor or hardware security module.

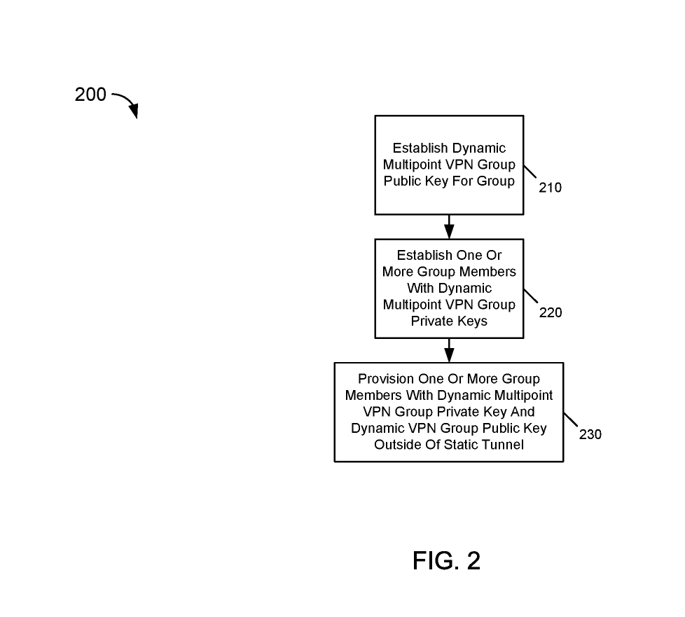

Referring now to FIG. 2, shown is a flow diagram of a method in accordance with one embodiment of the present invention. As shown in FIG. 2, method 200 may be performed by a hub server in accordance with an embodiment of the present invention. More specifically, a hub server may be configured with hardware, software, firmware and/or combinations thereof to perform method 200. Understand that in given embodiments, a hub server may include one or more processors, such as a multicore processor or other SoC, which may include general-purpose and/or dedicated circuitry to perform method 200 of FIG. 2. Note that a given hub server may be a private server or other computing device of a domain owner such as a given enterprise, building, home, business or so forth. In other cases, the hub server may be a cloud-based server of a public datacenter that provides group key provisioning services as described herein.

In any event, method 200 begins by establishing a DMVPN group public key for a group (block 210). Understand that this group may be formed for a collection of devices that perform a common function. For purposes of discussion, assume that this common function is a temperature sensing function. At block 220, the group members may interact with the group leader to establish DMVPN group private keys. Understand that such operation at block 220 may occur whenever a device is to join the group, e.g., using an Intel® EPID Join protocol. Next, control passes to block 230 where the DMVPN group public key and group private key can be provisioned for the group member(s). Note that this provisioning of DMVPN group keys may be performed as a one-time event between the hub server and a corresponding device of the group, and may occur outside of a static tunnel to couple the hub server and device (as no such static tunnel need be set up in accordance with the embodiments here). Note further with regard to FIG. 2 that after this group key provisioning process is performed between a hub system and a given group member, no further communications may occur between the devices. However, in some cases, group symmetric keys can be provided to a joining member, as described below.

Note that the DMVPN group private key(s) may be used to authenticate a key exchange protocol that establishes a group symmetric key that may be used to protect packets via an IP security (IPsec) protocol. An IPsec protocol may be defined over a multicast address such that a single sender may cause protected messages (encrypted/keyed-hash message authentication code (HMAC) integrity protected) to multiple recipients concurrently. Using encrypted IPsec packets, only recipients who are members of the group receive a pre-shared key (PSK) with which to decrypt packets. Even if a multicast subscriber is routed packets, without group membership, such subscriber cannot decrypt packets. Further, for integrity protected packets, non-member recipients may read packet contents but may not be able to possess the HMAC key used to authenticate the packet as originating from a group member and hence the senders retain a high degree of repudiation.

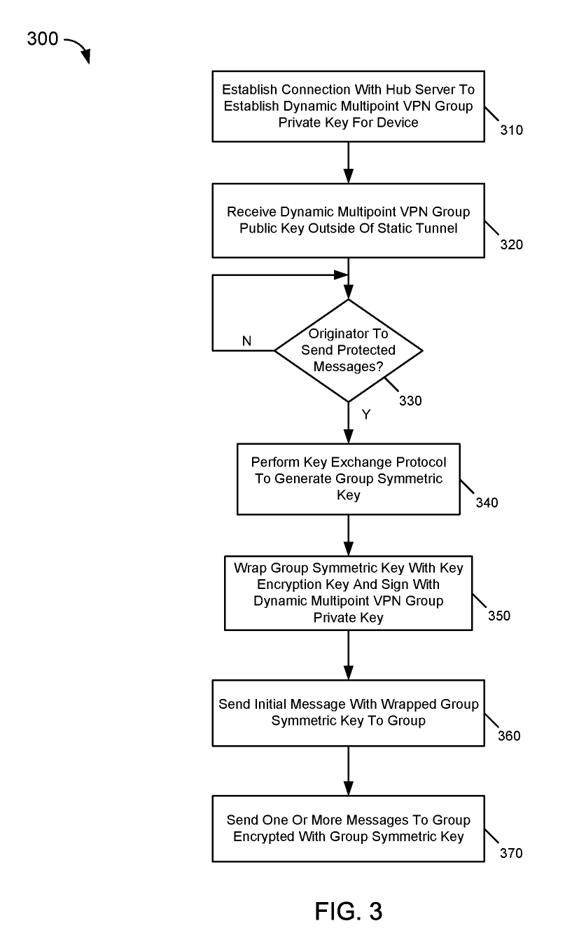

Referring now to FIG. 3, shown is a flow diagram of a method in accordance with another embodiment of the present invention. More specifically, method 300 shown in FIG. 3 may be performed by a given member of a group, as implemented in any type of device, such as an IoT or other computing device that is provisioned within a particular group. To this end, the given computing device may include one or more processors, such as a multicore processor or other SoC, which may include general-purposes and/or dedicated circuitry to perform method 300. As illustrated, method 300 begins by establishing a connection with a hub server to establish a DMVPN group private key, such as by way of an Intel® EPID Join protocol (block 310). Next at block 320, the device receives a DMVPN group public key, outside of a static tunnel, as described above.

As further illustrated in FIG. 3, next at diamond 330 it can be determined whether this device is to be an originator to send protected messages. For example, the given device may be a publisher device, such as a device having a sensor to send monitoring information, e.g., from one or more sensors (or other functions) of the device. In other cases, the device may be another type of originator of messages in a publish-subscribe model. If this device is to be an originator, control passes to block 340 where a key exchange protocol is performed to generate a group symmetric key. Understand that this key exchange protocol may occur between this originator device and at least one recipient device. These group symmetric keys may be used for purposes of message integrity and/or confidentiality. In one example, a sender uses a random number generator (RNG) to generate the symmetric key locally. In another example, a symmetric key generated locally then may be sent to a key distribution center (e.g., a Kerberos system). Signaling may cause group members to request the key (e.g., via a Fluffy mechanism, based on “Fluffy: Simplified Key Exchange for Constrained Environments, draft-hardjono-ace-fluffy-00” (draft IETF Specification Mar. 23, 2015)). The message can be encrypted and sent asynchronously to the key distribution mechanism. In still other examples, a group key exchange protocol is applied, e.g., using Diffie-Hellman exchanges using the same g^{a} and g^{b} such that the symmetric key value is the same for each member. With this option, perfect forward secrecy (PFS) can be realized, as a compromise of the current keys does not place in jeopardy security of past session keys.

Still referring to FIG. 3, control next passes to block 350 where this group symmetric key can be wrapped. More specifically, in an embodiment the group symmetric key can be wrapped with a KEK. As examples, the KEK may be a Rivest Shamir Adleman (RSA) or learning with errors (LWE) KEK. Still further, this wrapped group symmetric key can be signed using the DMVPN group private key of the originator device.

Note that in other cases, at least some pre-established KEKs can be provided from the group leader. That is, in some embodiments, there may be different approaches for KEK distribution among group members. A first approach allows each group member to possess a different asymmetric KEK pair, where the public KEK value is communicated to the group leader at the time the member joins the group. In response, all previously joined members' KEK public keys are returned to the new member, and a multicast message containing the new member public KEK is created and sent to all existing members using an embodiment herein to securely send a message to the group.

A second approach relies on a shared symmetric KEK key, where the shared key is provisioned to the new member using a direct secure channel such as a Diffie-Hellman channel, simple password exponential key exchange (SPEKE) or password authenticated key exchange (PAKE) protocol. Once provisioned, the group symmetric keys(s) may be wrapped using the shared symmetric KEK. This approach has the advantage of group keys being wrapped once for all members; however any group member could be compromised by a non-member to allow the non-member to produce encrypted/HMAC'ed messages. To mitigate this risk, the KEK can change periodically; hence members may periodically check in with the group leader to obtain an updated key.

Still referring to FIG. 3, control next passes to block 360, where an initial message can be sent to the group. More specifically, this initial message includes the wrapped group symmetric key. Of course additional information may be included in such message, e.g., including configuration information to enable receivers of the initial message to configure an IP layer of the DMVPN using the symmetric key and other information of the message, including the multicast address that will be used when protecting packets exchanged with group members. Finally with reference still to FIG. 3, control passes to block 370 where one or more additional messages may be sent to the group. Understand that these additional messages such as monitoring information or so forth may be encrypted using the group symmetric key, such that secure communications with different devices in the DMVPN can occur while enabling the receiving devices to obtain the underlying message content. Understand while shown at this high level in the embodiment of FIG. 3, many variations and alternatives are possible.

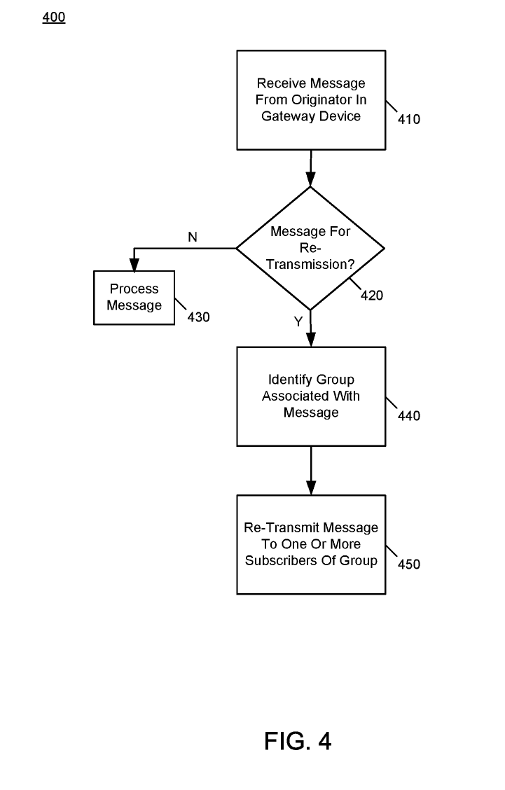

Referring now to FIG. 4, shown is a flow diagram of a method in accordance with a still further embodiment of the present invention. More specifically, method 400 shown in FIG. 4 may be performed by a gateway device. In embodiments, such gateway device may act as an intermediary between a given device and one or more other devices in a DMVPN. For example, a gateway device may be a mobile terminal or other portable computing device. In one embodiment, such gateway device may include a processor having an Intel® Active Management Technology (AMT) to perform method 400, e.g., on a manageability engine (which may be part of the processor or a separate co-processor in different embodiments).

To enable efficient publication of messages from originator devices, which may be low power or other devices that are only occasionally active and/or connected to a network, a gateway device may act as a re-transmission source to receive incoming messages from one or more devices and re-transmit the messages to appropriate members of a given group.

To this end, method 400 begins by receiving a message in the gateway device from an originator (block 410). Next it is determined at diamond 420 whether the message is to be re-transmitted. For example, a message header may indicate, by way of a re-transmission indicator, whether the message is to be retransmitted. In other cases, a destination identifier of the message may indicate whether the message is intended for the gateway device only or instead is a multicast or broadcast message to be sent to select or all members of a given group. If the message is not for re-transmission, control passes to block 430 where the message is processed locally. For example, the message may be a configuration message for the gateway device or some other message intended solely for consumption within the gateway device.

Still with reference to FIG. 4, if it is determined that the message is for purposes of re-transmission, control passes to block 440 where a group associated with the message can be identified. As one example, a gateway device may include a table or other storage that includes a list of groups and corresponding members of the group. Then based at least in part on a group indicator of the message, the gateway device can identify the associated group. Thereafter, control passes to block 450 where the message can be re-transmitted to one or more subscribers of the group. For example, the gateway device may store, within the same table or a different table structure, a list of group members to which the gateway device is to re-transmit messages. For example, such devices may be a collection of devices in local proximity to the gateway device. Instead for purposes of further re-transmission, a first gateway device may couple in turn to one or more other gateway devices, which can then push the message to further members of a group. Understand while shown at this high level in the embodiment of FIG. 4, many variations and alternatives are possible.

As described above, in one embodiment, an EPID Join protocol may be used by a member to interact with the issuer to obtain a unique Intel® EPID private key such that the member's private key is unknown to the issuer. Note that the issuer may authenticate the member through other mechanisms. The join protocol has the following steps, in one embodiment:
1. A hub server (Issuer) chooses an EPID group for the DMVPN. Let gid be the chosen group ID. Let (gid, h1, h2, w) (where h1 and h2 are elements in G1 and w is an element of G2, used to generate a group public key) be the group public key and (gid, gamma) (where gamma is an integer between [1, p−1] be the group issuing private key. The gid may be chosen to be a 128-bit value corresponding to a multicast address. If the address is shorter it will be padded with zeros.
2. Let NI be a 256-bit nonce chosen by the issuer.
3. The member chooses a random integer f between [1, p−1] or derives f between [1, p−1] from some seed value. This step is out of the scope of this specification.
4. The member runs a JoinP process to create a join request (F, c, s) (where c and s are integers between [1, p−1]. The JoinP process is specified below.
5. The member sends the join request (F, c, s) to the issuer.
6. The issuer runs the JoinI process to create a membership credential (gid, A, x) (where A is an element of G1 and x is an integer between [1, p−1] for the member. The JoinI process is specified below.
7. The issuer sends the membership credential (gid, A, x) to the member.
8. The member concatenates the membership credential (gid, A, x) received and the f value generated in step 3 into an EPID private key (gid, A, x, f). The member can validate the private key, e.g., as specified by a PKI server.

The details of a JoinP algorithm in accordance with an embodiment of the present invention is specified in Table 1:

TABLE 1
Input

(gid, h1, h2, w): an EPID group public key
f: an integer between [1, p−1]
NI: a 256-bit string

Output

(F, c, s): a join request

Steps
The following variables F, R (elements of G1), and r, c, s (256-bit
integers) are used.

| | |
|---|---|
| 1. | The member chooses a random integer r from [1, p−1]. |
| 2. | The member computes F = G1.sscmExp(h1, f). |
| 3. | The member computes R = G1.sscmExp(h1, r). |
| 4. | The member computes c = Fp.hash(p ∥ g1 ∥ g2 ∥ h1 ∥ h2 ∥ w ∥ F ∥ R ∥ |
| | NI). |
| 5. | The member computes s = (r + c · f) mod p. |
| 6. | The output join request is (F, c, s). |

The details of a JoinI algorithm in accordance with an embodiment of the present invention is specified in Table 2:

TABLE 2
Input

(gid, h1, h2, w): an EPID group public key
(gid, gamma): the issuing private key corresponding to the
public key
NI: a 256-bit string
(F, c, s): a join request

Output

(gid, A, x): a membership credential

Steps
The following variables R, t3, A (elements of G1), and nc, x, t1, t2
(256-bit integers) are used.

| | |
|---|---|
| 1. | The issuer verifies G1.inGroup(F) is true. |
| 2. | The issuer verifies s in [0, p−1]. |
| 3. | The issuer computes nc = (−c) mod p. |
| 4. | The issuer computes R = G1.multiExp(h1, s, F, nc). |
| 5. | The issuer verifies c = Fp.hash(p ∥ g1 ∥ g2 ∥ h1 ∥ h2 ∥ w ∥ F ∥ R ∥ |
| | NI). |
| 6. | If any of the above verifications fail, the join request is |
| | invalid, and the issuer aborts and outputs failure. |
| 7. | The issuer chooses x randomly from [1, p−1]. |
| 8. | The issuer computes integer t1 = (gamma + x) mod p. |
| 9. | The issuer computes integer t2 = inverse(t1) mod p, the inverse of |
| | t1 modulo p. |
| 10. | The issuer computes t3 = G1.mul(g1, F). |
| 11. | The issuer computes A = G1.exp(t3, t2). |
| 12. | The output membership credential is (gid, A, x). |

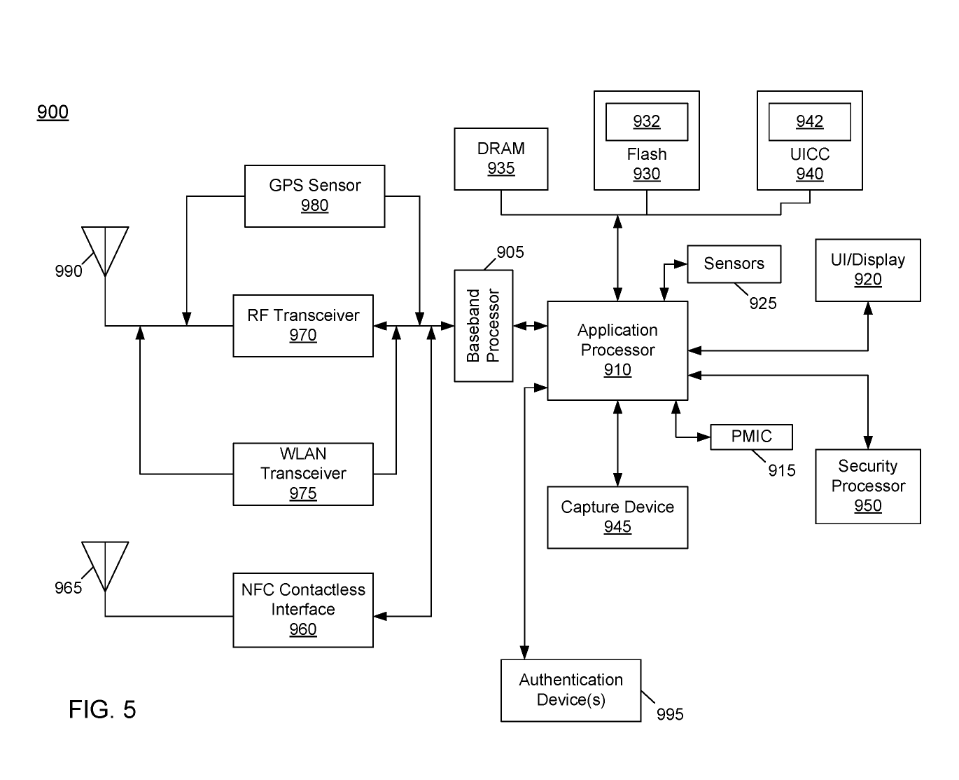

Referring now to FIG. 5, shown is a block diagram of an example system with which embodiments can be used. System 900 may be a given client to be at least temporarily included as a member in a DMVPN. In an example, system 900 may be a smartphone or other wireless communicator or any other IoT device. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920, e.g., a touch screen display. In addition, application processor 910 may couple to a memory system including a non-volatile memory, namely a flash memory 930 and a system memory, namely a DRAM 935. In some embodiments, flash memory 930 may include a secure portion 932 in which secrets and other sensitive information may be stored. As further seen, application processor 910 also couples to a capture device 945 such as one or more image capture devices that can record video and/or still images.

Still referring to FIG. 5, a universal integrated circuit card (UICC) 940 comprises a subscriber identity module, which in some embodiments includes a secure storage 942 to store secure user information. System 900 may further include a security processor 950 that may that may implement a TEE, and which may couple to application processor 910. Furthermore, application processor 910 may implement a secure mode of operation, such as Intel® SGX extensions to a given instruction set architecture, and circuitry for hosting of a TEE. Security processor 950 and/or application processor 910 may be configured to be a group member and receive a group public key and generate a group private key based on interaction with a hub server, as described herein, to enable system 900 to interact with other devices in a DMVPN. Still further, security processor 950 and/or application processor 910 may be configured to perform symmetric key exchanges with one or more peer devices in a DMVPN without further interaction with a hub server. A plurality of sensors 925, including one or more multi-axis accelerometers may couple to application processor 910 to enable input of a variety of sensed information such as motion and other environmental information. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 5, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received such as in one or more IoT networks, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein when context information is to be used in a pairing process. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

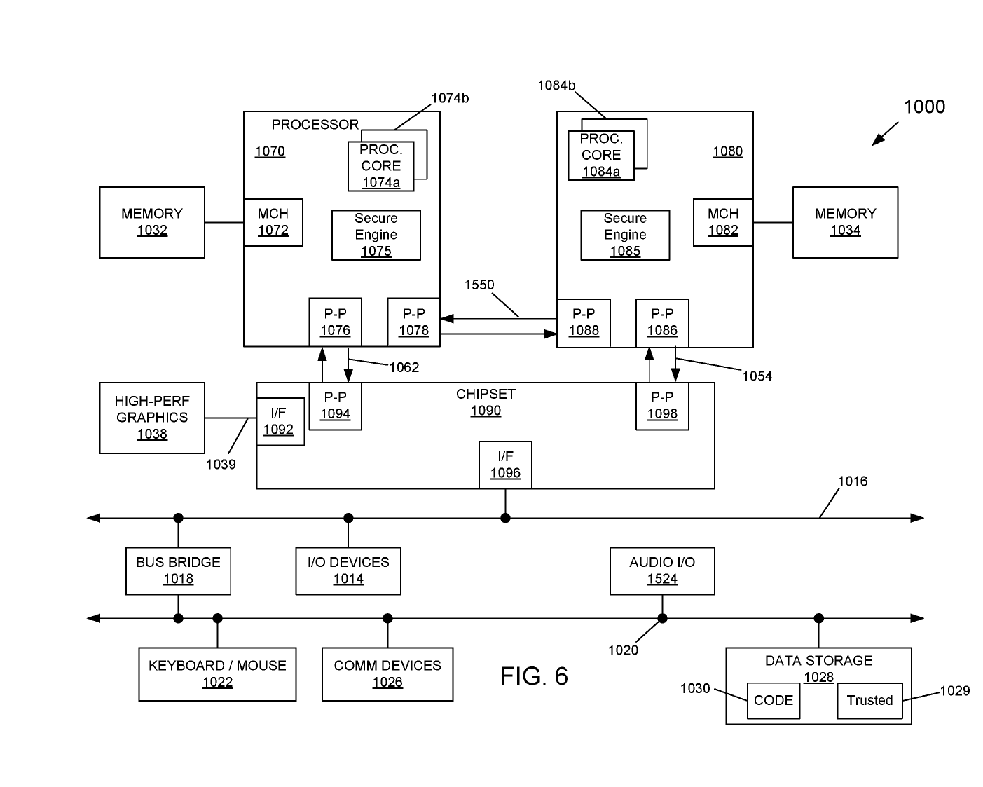

Referring now to FIG. 6, shown is a block diagram of a system in accordance with another embodiment of the present invention. As shown in FIG. 6, multiprocessor system 1000 is a point-to-point interconnect system such as a server system, and includes a first processor 1070 and a second processor 1080 coupled via a point-to-point interconnect 1050. In an embodiment, system 1000 may be a hub server, which may be implemented as a public cloud service, or as a dedicated system with a given entity or other domain owner to act as a group leader as described herein. As shown in FIG. 6, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include a secure engine 1075 and 1085 to perform group key generation (e.g., using a group ID based at least in part on a subnet IP address) and group private membership credential generation operations as described herein, among other operations.

Still referring to FIG. 6, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 6, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 6, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 6, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device. As seen, data storage unit 1028 may include code 1030, in one embodiment. As further seen, data storage unit 1028 also includes a trusted storage 1029 to store sensitive information to be protected. Further, an audio I/O 1024 may be coupled to second bus 1020.

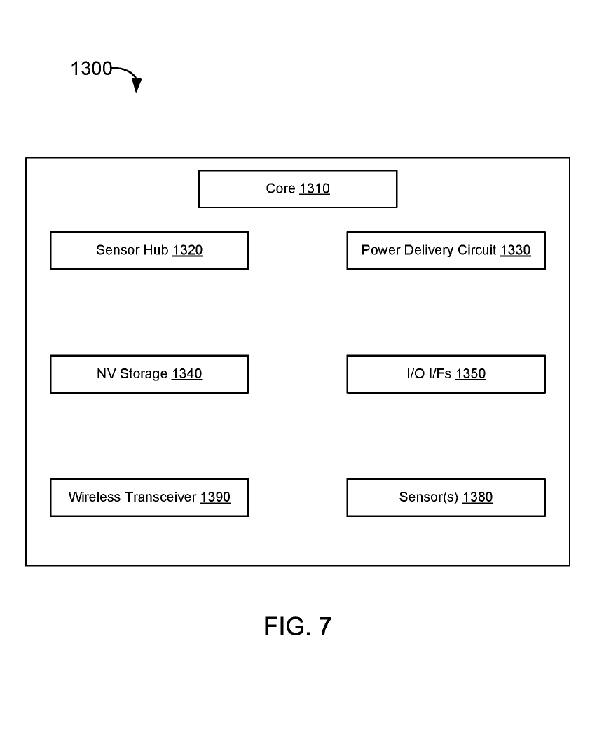

Embodiments may be used in environments where IoT devices may include wearable devices or other small form factor IoT devices. Referring now to FIG. 7, shown is a block diagram of a wearable module 1300 in accordance with another embodiment. In one particular implementation, module 1300 may be an Intel® Curie™ module that includes multiple components adapted within a single small module that can be implemented as all or part of a wearable device. Module 1300 may be configured to be a client device for inclusion in a DMVPN, as described herein. As seen, module 1300 includes a core 1310 (of course in other embodiments more than one core may be present). Such core may be a relatively low complexity in-order core, such as based on an Intel Architecture® Quark™ design. In some embodiments, core 1310 may implement a TEE as described herein. Core 1310 couples to various components including a sensor hub 1320, which may be configured to interact with a plurality of sensors 1380, such as one or more biometric, motion environmental or other sensors. A power delivery circuit 1330 is present, along with a non-volatile storage 1340. In an embodiment, this circuit may include a rechargeable battery and a recharging circuit, which may in one embodiment receive charging power wirelessly. One or more input/output (IO) interfaces 1350, such as one or more interfaces compatible with one or more of USB/SPI/I²C/GPIO protocols, may be present. In addition, a wireless transceiver 1390, which may be a Bluetooth™ low energy or other short-range wireless transceiver is present to enable wireless communications as described herein. Understand that in different implementations a wearable module can take many other forms. Wearable and/or IoT devices have, in comparison with a typical general purpose CPU or a GPU, a small form factor, low power requirements, limited instruction sets, relatively slow computation throughput, or any of the above.

The following Examples pertain to further embodiments.

In Example 1, a system includes: a hardware processor having at least one core to execute instructions; and a hub logic to provision a plurality of group private keys for a DMVPN group associated with a function of a plurality of devices, provide a group public key for the DMVPN group to the plurality of devices and provision each of the plurality of group private keys to one of the plurality of devices, to enable one or more subsets of the plurality of devices to negotiate a traffic encryption key without interaction with the system.

In Example 2, the hub logic is to select a group name for the DMVPN group, the group name corresponding at least in part to a multicast address for the DMVPN.

In Example 3, the system further comprises a network interface circuit to couple the system to the plurality of devices, where the network interface circuit is to communicate the group public key and protocol messages with the plurality of devices to enable the provision of the plurality of group private keys to the plurality of devices outside of a static tunnel.

In Example 4, the hub logic is to provision a plurality of second group private keys for a second DMVPN group associated with a second function of at least a portion of the plurality of devices, provide a second group public key for the second DMVPN group to at least the portion of the plurality of devices and provision each of the plurality of second group private keys to one of the at least portion of the plurality of computing devices.

In Example 5, the system comprises a cloud service of a datacenter, the datacenter independent of an owner of the plurality of devices.

In Example 6, the hub logic is to provision the plurality of group private keys to the plurality of computing devices via one-time connections.

In Example 7, the system comprises a hub server to couple to the plurality of devices via hub-spoke connections, and the one or more subsets of the plurality of devices are to negotiate the traffic encryption key via spoke-to-spoke exchange.

In Example 8, the hub logic of one or more of the above Examples is to: receive a first asymmetric key from a first device of the plurality of devices and store the first asymmetric key in a key table; and responsive to a join of a second device of the plurality of devices to the DMVPN group, send the first asymmetric key to the second device.

In Example 9, the hub logic of Example 8 is to send a multicast message to at least some of the plurality of devices to provide the first asymmetric key to the at least some devices.

In Example 10, a method includes: obtaining a DMVPN group public key from a group manager, where the group manager is to manage a group including a plurality of computing devices; performing a DMVPN group private key protocol with the group manager to provision a DMVPN group private key; performing a key encryption protocol with at least one computing device of the group to generate a group symmetric key; and sending a first message with the group symmetric key to the at least one computing device of the group via a point-to-point connection within the DMVPN.

In Example 11, the method further comprises wrapping the group symmetric key with a key encryption key.

In Example 12, the method of Example 11 further comprises signing the wrapped group symmetric key with the DMVPN group private key.

In Example 13, the method of one or more of the above Examples further comprises sending the first message and thereafter entering into a sleep state, where the at least one computing device comprises a gateway device, the gateway device to re-transmit the first message to one or more other computing devices of the group while the system is in the sleep state.

In Example 14, the method further comprises: receiving a second message from a second computing device of the plurality of computing devices, the second message including a second group symmetric key; and configuring a DMVPN tunnel between the system and the second computing device based at least in part on the second message.

In Example 15, the method of Example 14 further comprises: receiving a third message from the second computing device, the third message encrypted with the second group symmetric key; and decrypting the third message using the second group symmetric key.

In another Example, a computer readable medium including instructions is to perform the method of any of the above Examples.

In a further Example, a computer readable medium including data is to be used by at least one machine to fabricate at least one integrated circuit to perform the method of any one of the above Examples.

In a still further Example, an apparatus comprises means for performing the method of any one of the above Examples.

In Example 16, a system includes: a plurality of computing devices, where the plurality of computing devices includes a function associated with a group; and a provisioning server coupled to the plurality of computing devices, where the provisioning server is to generate a group public key for the group and provision a plurality of group private keys for the plurality of computing devices, provide the group public key to the plurality of computing devices and provision each of the plurality of group private keys to one of the plurality of computing devices, where at least some of the plurality of computing devices are to perform one or more point-to-point symmetric key exchange protocols using the corresponding group private key, and without involvement of the provisioning server.

In Example 17, the provisioning server is to select the group public key to correspond to at least a portion of an IP address of a DMVPN.

In Example 18, the plurality of computing devices are coupled via the DMVPN.

In Example 19, at least some of the plurality of computing devices are further coupled via a second DMVPN, the first DMVPN associated with the group and the second DMVPN associated with a second group associated with a second function included in the at least some of the plurality of computing devices.

In Example 20, the provisioning server is to: receive a first asymmetric key from a first device of the plurality of computing devices and store the first asymmetric key in a key table, and responsive to a join of a second computing device of the plurality of computing devices to the group, send the first asymmetric key to the second computing device; and send a multicast message to at least some of the plurality of computing devices to provide the first asymmetric key to the at least some computing devices.

In Example 21, a system comprises: core means for executing instructions; and means for provisioning a plurality of group private keys for a DMVPN group associated with a function of a plurality of devices; means for providing a group public key for the DMVPN group to the plurality of devices; and means for provisioning each of the plurality of group private keys to one of the plurality of devices, to enable one or more subsets of the plurality of devices to negotiate a traffic encryption key without interaction with the system.

In Example 22, the system further comprises means for selecting a group name for the DMVPN group, the group name corresponding at least in part to a multicast address for the DMVPN.

In Example 23, the system further comprises network interface means for coupling the system to the plurality of devices, where the network interface means is to communicate the group public key and protocol messages with the plurality of devices to enable the provisioning of the plurality of group private keys to the plurality of devices outside of a static tunnel.

In Example 24, the system further comprises: means for provisioning a plurality of second group private keys for a second DMVPN group associated with a second function of at least a portion of the plurality of devices; means for providing a second group public key for the second DMVPN group to at least the portion of the plurality of devices; and means for provisioning each of the plurality of second group private keys to one of the at least portion of the plurality of computing devices.

Understand that various combinations of the above Examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system comprising:
a hardware processor having at least one core to execute instructions; and
a hub logic to provision a plurality of group private keys for a dynamic multipoint virtual private network (DMVPN) group associated with a function of a plurality of devices, provide a group public key for the DMVPN group to the plurality of devices and provision each of the plurality of group private keys to one of the plurality of devices, to enable one or more subsets of the plurality of devices to negotiate a traffic encryption key without interaction with the system.

2. The system of claim 1, wherein the hub logic is to select a group name for the DMVPN group, the group name corresponding at least in part to a multicast address for the DMVPN.

3. The system of claim 1, further comprising a network interface circuit to couple the system to the plurality of devices, wherein the network interface circuit is to communicate the group public key and protocol messages with the plurality of devices to enable the provision of the plurality of group private keys to the plurality of devices outside of a static tunnel.

4. The system of claim 1, wherein the hub logic is to provision a plurality of second group private keys for a second DMVPN group associated with a second function of at least a portion of the plurality of devices, provide a second group public key for the second DMVPN group to at least the portion of the plurality of devices and provision each of the plurality of second group private keys to one of the at least portion of the plurality of computing devices.

5. The system of claim 1, wherein the system comprises a cloud service of a datacenter, the datacenter independent of an owner of the plurality of devices.

6. The system of claim 1, wherein the hub logic is to provision the plurality of group private keys to the plurality of computing devices via one-time connections.

7. The system of claim 1, wherein the system comprises a hub server to couple to the plurality of devices via hub-spoke connections, and the one or more subsets of the plurality of devices are to negotiate the traffic encryption key via spoke-to-spoke exchange.

8. The system of claim 1, wherein the hub logic is to:
receive a first asymmetric key from a first device of the plurality of devices and store the first asymmetric key in a key table; and
responsive to a join of a second device of the plurality of devices to the DMVPN group, send the first asymmetric key to the second device.

9. The system of claim 8, wherein the hub logic is to send a multicast message to at least some of the plurality of devices to provide the first asymmetric key to the at least some devices.

10. At least one computer readable storage medium comprising instructions that when executed enable a system to:
obtain a dynamic multipoint virtual private network (DMVPN) group public key from a group manager, wherein the group manager is to manage a group including a plurality of computing devices;
perform a DMVPN group private key protocol with the group manager to provision a DMVPN group private key;
perform a key encryption protocol with at least one computing device of the group to generate a group symmetric key; and
send a first message with the group symmetric key to the at least one computing device of the group via a point-to-point connection within the DMVPN.

11. The at least one computer readable medium of claim 10, further comprising instructions that when executed enable the system to wrap the group symmetric key with a key encryption key.

12. The at least one computer readable medium of claim 11, further comprising instructions that when executed enable the system to sign the wrapped group symmetric key with the DMVPN group private key.

13. The at least one computer readable medium of claim 10, further comprising instructions that when executed enable the system to send the first message and thereafter enter into a sleep state, wherein the at least one computing device comprises a gateway device, the gateway device to re-transmit the first message to one or more other computing devices of the group while the system is in the sleep state.

14. The at least one computer readable medium of claim 10, further comprising instructions that when executed enable the system to:
receive a second message from a second computing device of the plurality of computing devices, the second message including a second group symmetric key; and
configure a DMVPN tunnel between the system and the second computing device based at least in part on the second message.

15. The at least one computer readable medium of claim 14, further comprising instructions that when executed enable the system to:
receive a third message from the second computing device, the third message encrypted with the second group symmetric key; and
decrypt the third message using the second group symmetric key.

16. A system comprising:
a plurality of computing devices, wherein the plurality of computing devices includes a function associated with a group; and
a provisioning server coupled to the plurality of computing devices, wherein the provisioning server is to generate a group public key for the group and provision a plurality of group private keys for the plurality of computing devices, provide the group public key to the plurality of computing devices and provision each of the plurality of group private keys to one of the plurality of computing devices, wherein at least some of the plurality of computing devices are to perform one or more point-to-point symmetric key exchange protocols using the corresponding group private key, and without involvement of the provisioning server.

17. The system of claim 16, wherein the provisioning server is to select the group public key to correspond to at least a portion of an Internet protocol (IP) address of a dynamic multipoint virtual private network (DMVPN).

18. The system of claim 17, wherein the plurality of computing devices are coupled via the DMVPN.

19. The system of claim 18, wherein at least some of the plurality of computing devices are further coupled via a second DMVPN, the first DMVPN associated with the group and the second DMVPN associated with a second group associated with a second function included in the at least some of the plurality of computing devices.

20. The system of claim 16, wherein the provisioning server is to:
receive a first asymmetric key from a first device of the plurality of computing devices and store the first asymmetric key in a key table, and responsive to a join of a second computing device of the plurality of computing devices to the group, send the first asymmetric key to the second computing device; and
send a multicast message to at least some of the plurality of computing devices to provide the first asymmetric key to the at least some computing devices.
